(19) United States
(12) Patent Application Publication
(10) Pub. No.: US 2019/0118405 A1
(43) Pub. Date: Apr. 25, 2019

(54) SAW CHAIN CUTTING TEETH AND SAW CHAIN

(71) Applicant: David Lance Stubbs, Hurricane, AZ (US)

(72) Inventor: David Lance Stubbs, Hurricane, AZ (US)

(21) Appl. No.: 15/792,670

(22) Filed: Oct. 24, 2017

Related U.S. Application Data
(60) Provisional application No. 62/575,149, filed on Oct. 20, 2017.

(51) Int. Cl. B27B 33/14

(52) U.S. Cl. CPC B27B 33/142; B27B 17/00; B27B 33/141

(57) ABSTRACT

A chisel cutter for use with a saw chain, the chisel cutter having a heel having a coupling aperture, a toe having a coupling aperture, a gullet, a depth gauge, a side plate, and top plate; wherein the side plate forms a blade of a first length on the end proximal to the depth gauge, wherein after the first length of the blade, the top plate and side plate form a cutting corner, the top plate having an angled chisel extending therefrom; and wherein the depth gauge and the blade are in the same plane.

### CROSS-REFERENCE TO RELATED APPLICATIONS

This application claims the benefit of U.S. Provisional Application Ser. No. 62/575,149, filed on Oct. 20, 2017, which is incorporated herein by reference.

### TECHNICAL FIELD

The present disclosure relates to motor-driven chain saws. More particularly, the present disclosure relates to a saw chain and saw chain teeth for a motor-driven chain saw.

### BACKGROUND

Typical saw chains in the art include cutting links, connecting links, and drive links. The links are pivotally connected to one another via rivets. The cutting links can be scoring cutters or clearing cutters. Cutting links include 1) low profile cutters, which typically have a round radius edge and grind profile; 2) semi-chisel cutters, which also have a round radius edge and round grind edge; 3) full-chisel cutters, which have a square radius edge and a round grind profile; and 4) square chisel cutters, which have a square radius and square grind profile. Accordingly, several types of chains also exist, including 1) a full-house saw chain; 2) a full-skip saw chain; 3) a semi-skip saw chain; 4) a square ground saw chain; and 5) a ripping saw chain.

Notably, each cutting link has a depth gauge. The depth gauge sets the depth or thickness of the chip that will be produced by the cutting corner when it hooks and then severs fiber. Depth gauges function as a safety feature by regulating the size of the chip, which regulates the severity of reactive forces (i.e., kickback). The thicker the chip, the more severe the potential kickback. In the prior art, the depth gauge is positioned to gauge from the center of the kerf, which limits the depth of the scoring cutters, thereby limiting the amount of fiber that is clearable using the clearing cutters. Due the to the position of the gauge and the shape of the clearing teeth in the prior art, wood cutting remains inefficient. Therefore, there remains a need in the industry for a tooth-gauging system and tooth shape that allows a saw chain to cut faster and remain sharper for longer periods of time. The present invention seeks to solve these, and other, problems.

### SUMMARY OF EXAMPLE EMBODIMENTS

In one embodiment, a saw chain tooth comprises a heel having a coupling aperture, a toe having a coupling aperture, a gullet, a depth gauge, and a side plate forming a cutting corner; wherein the depth gauge and the cutting corner are in the same vertical geometric plane so that the depth gauge enters a scoring groove formed by the cutting corner, within the kerf.

In one embodiment, a saw chain tooth comprises a heel having a coupling aperture, a toe having a coupling aperture, a gullet, a depth gauge, a side plate, and top plate; wherein the side plate and the top plate form a cutting corner, the top plate having an angled chisel extending therefrom at about a 45-degree angle, and wherein the depth gauge and the cutting corner are in the same vertical geometric plane. In one embodiment, the angled chisel is serrated.

In one embodiment, a saw chain tooth comprises a heel having a coupling aperture, a toe having a coupling aperture, a gullet, a depth gauge, a side plate, and top plate; wherein the side plate forms a blade of a first length on the end proximal to the depth gauge, wherein after the first length of the blade, the top plate and side plate form a cutting corner, the top plate having an angled chisel extending therefrom; and wherein the depth gauge and the blade are in the same vertical geometric plane.

In one embodiment, a saw chain scoring cutter comprises a gauge in the same vertical geometric plane as a side plate so that the gauge is received within a scoring groove of the kerf.

In one embodiment, a saw chain chisel cutter comprises a top plate and a gauge in the same vertical geometric plane as a side plate; wherein the top plate has a cutting corner at about a 45-degree angle and a chisel running the length of the top plate. In one embodiment, the chisel is serrated.

In one embodiment, a saw chain chisel cutter comprises a top plate, a side plate, and a gauge in the same vertical geometric plane as the side plate; the side plate forms a blade of a first length on the end proximal to the depth gauge, wherein after the first length of the blade, the top plate and side plate form a cutting corner, wherein the angle of the cutting corner is an acute angle.

### BRIEF DESCRIPTION OF THE DRAWINGS

FIG. 1 is a perspective view of a scoring cutter;

FIG. 2 is a perspective view of a chisel cutter;

FIG. 3 is a perspective view of a chisel cutter with a serrated chisel;

FIG. 4 is a perspective view of a chisel cutter with a side-plate-forming blade and a serrated chisel;

FIG. 5 is a perspective view of a chisel cutter with a side-plate-forming blade and an acute-angled cutting corner;

FIG. 6 is a side elevation view of a saw chain;

FIG. 7 is a top plan view of a saw chain;

FIG. 8 is a side elevation view of a saw chain;

FIG. 9 is a top plan view of a saw chain;

FIG. 10 is a cross-sectional side elevation view of a saw chain cutting a kerf in wood;

FIG. 11 is a cross-sectional end elevation view of a scoring blade a kerf in wood;

FIG. 12 is a cross-sectional end elevation view of a saw chain cutting a kerf in wood;

FIG. 13 is a cross-sectional end elevation view of a saw chain cutting a kerf in wood; and

FIG. 14 is a detailed cutaway view of a saw chain cutting a kerf in wood.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

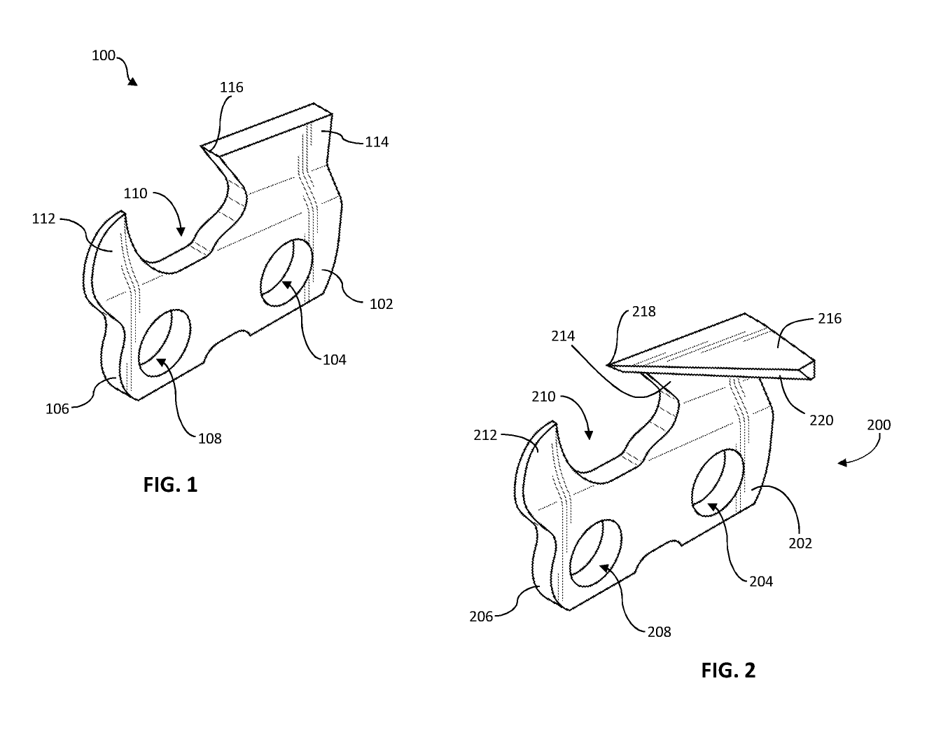

In one embodiment, as shown in FIG. 1, a saw chain tooth 100 (also referred to as a “scoring tooth”) comprises a heel 102 having a heel coupling aperture 104, a toe 106 having a toe coupling aperture 108, a gullet 110 formed between a depth gauge 112 and a side plate 114, the side plate 114 forming a cutting corner 116. The depth gauge 112 and the cutting corner 116 are in the same vertical geometric plane so that the depth gauge 112 enters a scoring groove formed by the cutting corner 116, the scoring groove located within the kerf. Because the cutting corner 116 and the depth gauge 112 are in the same vertical plane, the depth gauge gauges from the scoring groove within the kerf, rather than the kerf itself. Gauging from the scoring groove is an improvement over the art, as it allows a chisel blade to more effectively create a kerf

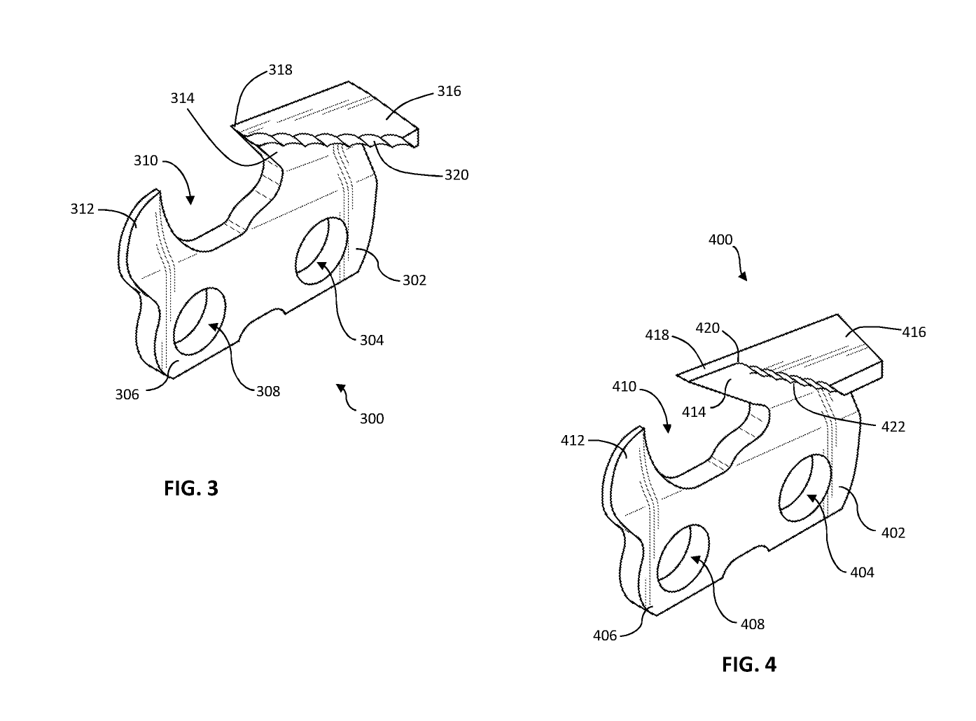

In one embodiment, as shown in FIG. 2, a saw chain tooth 200 (also referred to as a “chisel tooth”) comprises a heel 202 having a heel coupling aperture 204, a toe 206 having a toe coupling aperture 208, a gullet 210, a depth gauge 212, a side plate 214, and top plate 216. The side plate 214 and the top plate 216 form a cutting corner 218. The top plate 216 has an angled chisel 220 extending rearwardly from the cutting corner 218 at about a 45-degree angle (although numerous angles may be used). The depth gauge 212 and the cutting corner 218 are in the same vertical geometric plane, which allows the top plate 216 to more effectively remove wood and debris, creating the kerf faster and more efficiently than prior art teeth whose depth gauges gauge from the middle of the kerf instead. As shown in FIG. 3, a saw chain tooth 300 comprises a heel 302 having a heel coupling aperture 304, a toe 306 having a toe coupling aperture 308, a gullet 310, a depth gauge 312, a side plate 314, and top plate 316. The side plate 314 and the top plate 316 form a cutting corner 318. The top plate 316 has an angled, serrated chisel 320 extending rearwardly from the cutting corner 318 at about a 45-degree angle. As prior embodiments, the depth gauge 312 and the cutting corner 318 are in the same vertical geometric plane, which allows the top plate 416 to remove more wood and debris from the kerf. Further, the serrated chisel 320 allows for more efficient creation of the kerf in wood because of the serrations, which create varying impact points and thereby allow for easier penetration of the wood—instead of a solid chisel impacting at once. This is an improvement over the prior art, as saw chain teeth in the art are not serrated.

In one embodiment, as shown in FIG. 4, a saw chain tooth 400 comprises a heel 402 having a heel coupling aperture 404, a toe 406 having a toe coupling aperture 408, a gullet 410, a depth gauge 412, a side plate 414, and top plate 416. The side plate 414 forms a blade 418 of a first length on the end proximal to the depth gauge 412, wherein after the first length of the blade 418, the top plate 416 and side plate 414 form a cutting corner 420. The top plate 416 has an angled chisel 422 extending rearwardly (away from the depth gauge) from the cutting corner 420, creating an obtuse angle between the angled chisel 422 and the blade 418. The blade 418 enters the scoring groove within the kerf and is capable of cutting a deeper scoring groove, as gauged by the depth gauge 412. Despite the top plate 416 removing wood and debris from the kerf, the scoring groove is never completely removed due to the depth gauge 412 (as best seen in FIGS. 11-13). In other words, the angled chisel 422 is not able to clear wood as deep as the scoring groove within the kerf. However, the scoring groove is made deeper with the passing of each saw chain tooth 400 in the chain, and because the depth gauge 412 gauges from the scoring groove, the angled chisel 422 is able to remove significantly more wood and debris from the kerf. In other words, the depth gauge of the subsequent saw chain tooth enters the scoring groove created by the previous saw chain tooth.

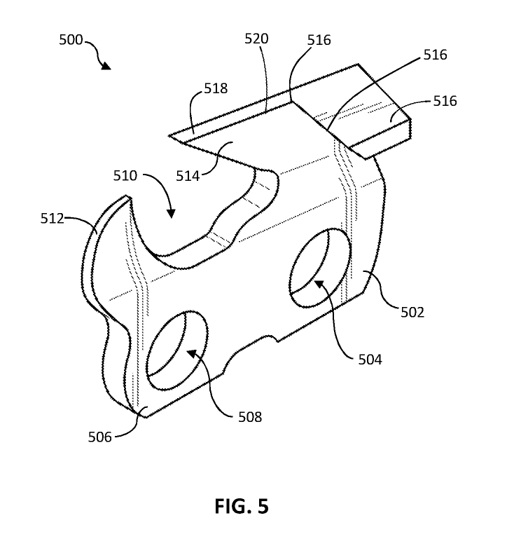

In one embodiment, as shown in FIG. 5, a saw chain tooth 500 comprises a heel 502 having a heel coupling aperture 504, a toe 506 having a toe coupling aperture 508, a gullet 510, a depth gauge 512, a side plate 514, and top plate 516. The side plate 514 forms a blade 518 of a first length on the end proximal to the depth gauge 512, wherein after the first length of the blade 518, the top plate 516 and side plate 514 form a cutting corner 520. The top plate 516 has an angled chisel 522 extending forwardly (toward the depth gauge 512) from the cutting corner 520, wherein the angle (i.e., the cutting corner 520) created by the angled chisel 522 and the blade 518 is an acute angle. The acute angle of the cutting corner 520 compensates for the forces on the blade 518. In other words, as the blade 518 impacts the wood, the blade 518, and tooth 500 in general, is biased in a first direction. As the acute-angled cutting corner 520 impacts the wood, it biases the tooth 500 in a second, opposite direction, to help keep the tooth 500 cutting straight.

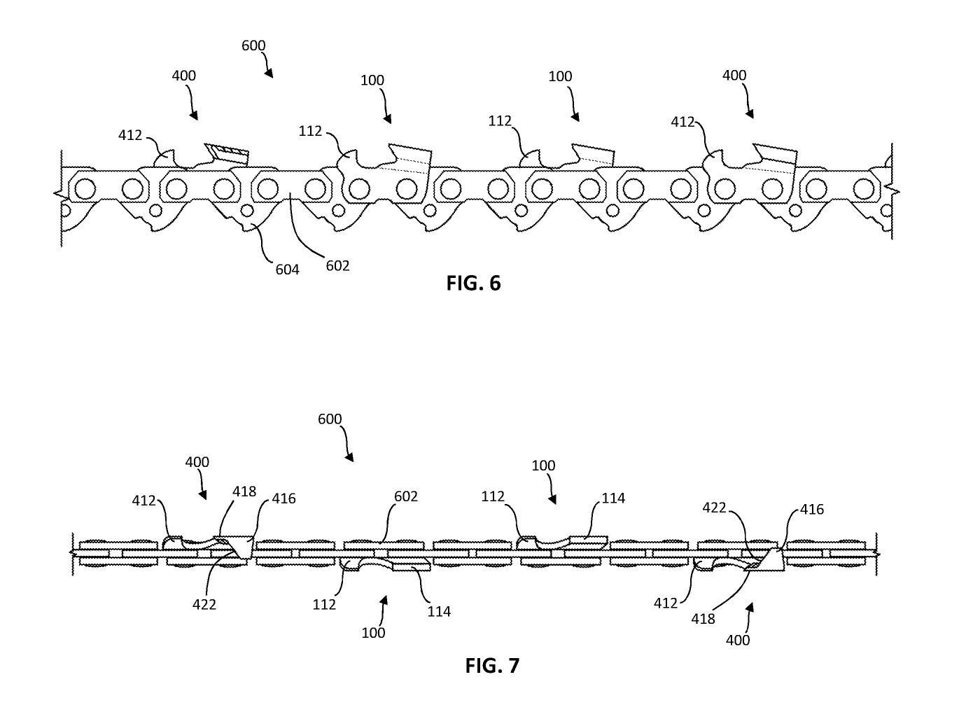

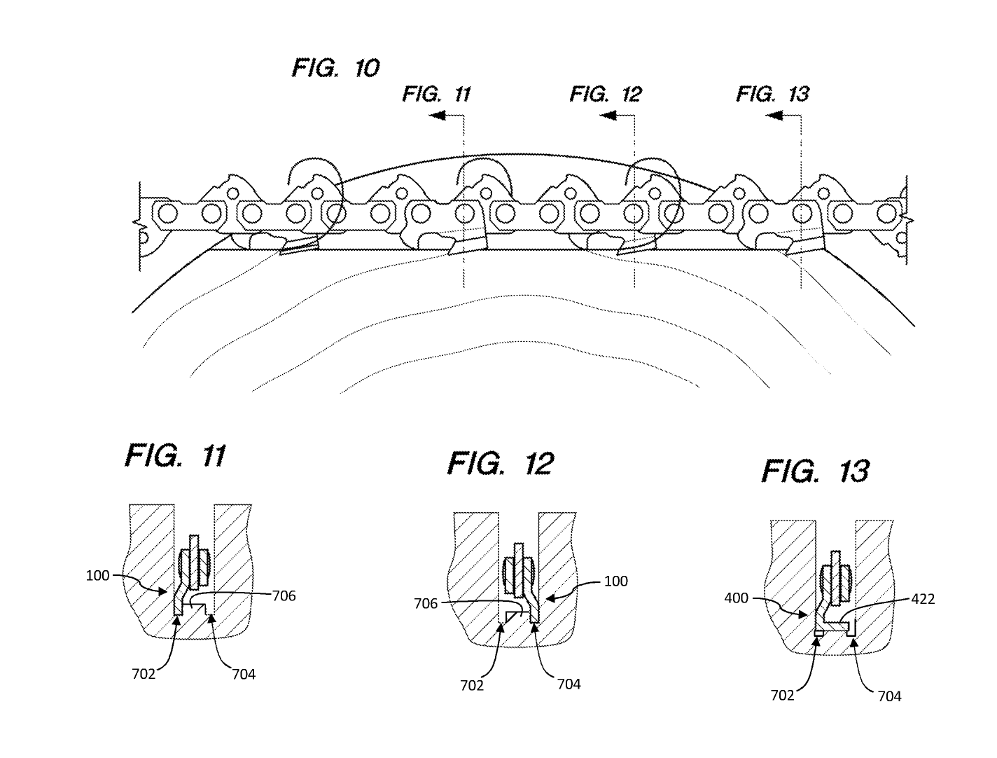

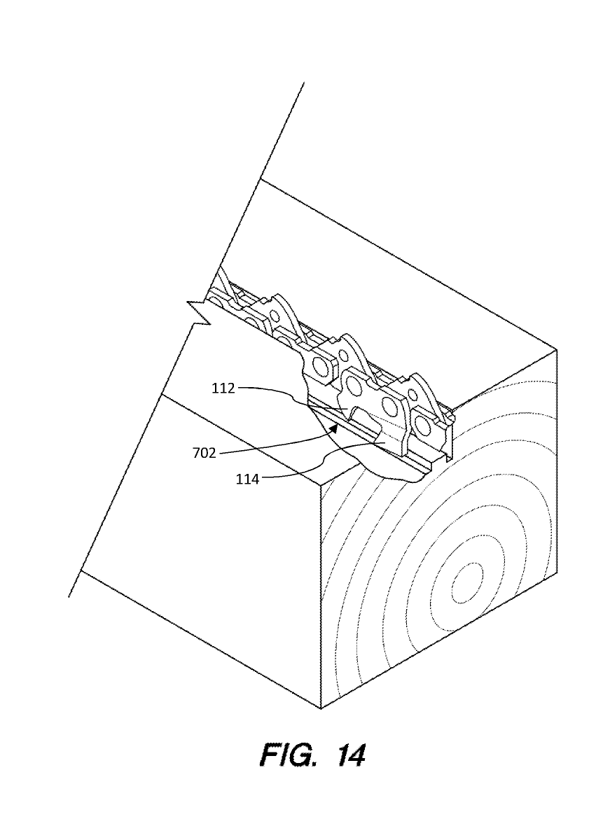

FIGS. 6-7 illustrate a saw chain 600 comprising a plurality of saw chain teeth. In one non-limiting example, as shown, the saw chain 600 may comprise scoring teeth 100 and chisel teeth 400. The scoring teeth 100 and the chisel teeth 400 are coupled using coupling links 602 and drive links 604, which are well-known in the art. As shown, a scoring tooth 100 is on each side of the chain 600. Each scoring tooth cuts a scoring groove in the wood. A chisel tooth 400 is also located on each side of the chain 600. As best shown in FIGS. 10-13, the depth gauge 412 of each chisel tooth 400 enters the scoring groove cut by the scoring teeth 100, with the top plate 416 removing the wood between the two scoring grooves, which creates the kerf in the wood. However, the top plate is not able to cut to the full depth of the scoring grooves due to the depth gauge of the chisel tooth 400 within the scoring groove. However, because the depth gauge enters the scoring groove, the wood is more easily removed between the two scoring grooves by the top plate 416. For example, as shown in FIGS. 11-14, a first scoring tooth 100 creates (or deepens) a first scoring groove 702 and a second scoring tooth 100 creates (or deepens) a second scoring groove 704, which forms a peak 706 of wood interposed between the two scoring grooves 702, 704. The depth gauge 412 of the chisel tooth 400 then enters the scoring groove and the top plate 416, which forms the angled chisel 422, then removes the majority of the peak 706 of wood. It is noted that the entire peak 706 is not removed and that scoring grooves 702, 704 remain even after the chisel tooth 400 has passed through the kerf. While FIG. 13 illustrates the angled chisel 422 as being parallel with the horizon, it will be appreciated that it may be angled as well.

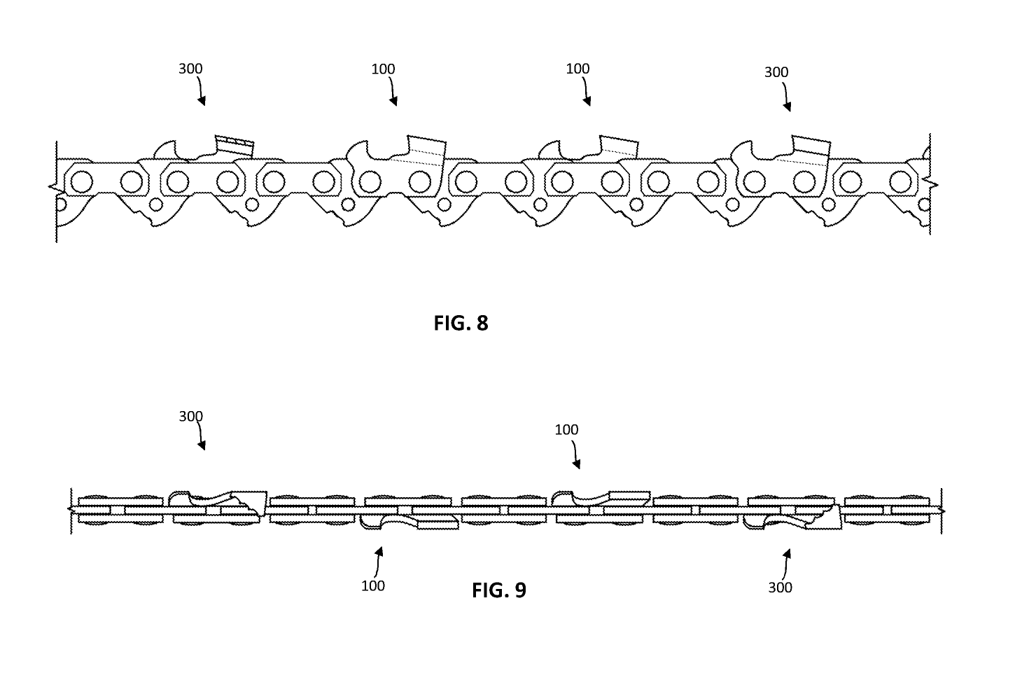

Referring back to FIGS. 8-9, a saw chain may comprise scoring teeth 100 and chisel teeth 300. Accordingly, it will be appreciated that any combination of teeth may be used on a chain, which may include scoring teeth, chisel teeth, or any combination of scoring teeth and chisel teeth.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein.

What is claimed is:

1. A saw chain tooth, comprising:
a heel having a heel coupling aperture, a toe having a toe coupling aperture, a gullet formed between a depth gauge and a side plate, the side plate forming a cutting corner; wherein the depth gauge and the cutting corner are in the same vertical geometric plane.

2. The saw chain tooth of claim 1, wherein the cutting corner comprises a serrated edge.

3. A saw chain tooth, comprising:
a heel having a heel coupling aperture, a toe having a toe coupling aperture, a gullet formed between a depth gauge and a side plate, and a top plate;
wherein the side plate and the top plate form a cutting corner, the top plate having an angled chisel extending rearwardly from the cutting corner, and wherein the depth gauge and the cutting corner are in the same plane.

4. The saw chain tooth of claim 3, wherein the angled chisel is serrated.

5. A saw chain tooth, comprising:
a heel having a coupling aperture, a toe having a coupling aperture, a gullet formed between a depth gauge and a side plate, and top plate;
wherein the side plate forms a blade of a first length on an end proximal to the depth gauge, the top plate and side plate form a cutting corner with the top plate having an angled chisel extending from the cutting corner; and
wherein the depth gauge and the blade are in the same vertical plane.

6. The saw chain tooth of claim 5, wherein the angled chisel extends rearwardly from the cutting corner, forming an obtuse angle between the blade and the top plate.

7. The saw chain tooth of claim 5, wherein the angled chisel extends forwardly from the cutting corner, forming an acute angle between the blade and the top plate.
